(19) United States
(12) Patent Application Publication
(10) Pub. No.: US 2026/0311025 A1
(43) Pub. Date: Oct. 8, 2026

(54) EFFICIENT ANNEALING SCHEDULING FOR DECOMPOSITION METHODS BASED ON SUBPROBLEM SIMILARITY CRITERIA

(71) Applicant: Dell Products L.P., Round Rock, TX (US)

(72) Inventors: Ítalo Gomes Santana, Rio de Janeiro (BR); Diego Vrague Noble, Pelotas (BR); Miguel Paredes Quiñones, Campinas (BR)

(21) Appl. No.: 19/098,826

(22) Filed: Apr. 2, 2025

(51) Int. Cl. G06N 10/60; G06F 17/11

(52) U.S. Cl. CPC G06N 10/60; G06F 17/11

(57) ABSTRACT

Selecting annealing schedules is disclosed. In a training phase, a model is trained using a scheduling dataset storing tuples of an annealing schedule, a problem, hardware properties. The tuples are generated by iteratively solving problems from a problem dataset using different annealing schedules. After reaching a termination criterion, the best annealing schedule is included in a tuple for the problem and stored in the scheduling dataset. In an inference phase, a problem is decomposed into subproblems that are then clustered. The model is used to select or infer an annealing schedule for representative subproblems selected from each of the clusters. The inferred annealing schedules assigned to the representative subproblems are used for the subproblems in the corresponding clusters. The subproblems are solved in quantum annealers and merged to determine a solution to the original problem.

### TECHNOLOGICAL FIELD OF THE DISCLOSURE

Embodiments disclosed herein generally relate to quantum annealing systems and methods. More particularly, at least some embodiments relate to systems, hardware, software, computer-readable media, and methods for determining annealing schedules for finding solutions to problems in quantum annealers.

### BACKGROUND

Quantum annealers are quantum computing systems or devices configured to solve problems such as optimization problems. Quantum annealers are generally configured to explore the solution search space based on quantum mechanics. Generally, a solution to a problem being optimized is determined by finding a minimum energy of a Hamiltonian equation that is related to the problem's objective function. Stated differently, an optimization problem may be represented as an energy landscape and the lowest energy configuration represents an optimal solution.

Optimization problems such as combinatorial problems (e.g., the traveling salesman problem) can be solved using quantum annealers because the search space can be broadly explored using quantum phenomena. One difficulty in quantum annealing is that the solution may correspond to a local minimum rather than a global minimum. The ability to effectively search the solution space is impacted by a variety of factors, including an annealing schedule.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of systems and methods for training a machine learning model to infer an annealing schedule;

FIG. 2 discloses aspects of systems and methods for inferring annealing schedules in the context of solving a problem using quantum annealing;

FIG. 3 discloses aspects of a training phase for training a machine learning model to infer an annealing schedule and aspects of an inference phase for inferring an annealing schedule or annealing schedules; and

FIG. 4 discloses aspects of a computing device, a computing system, or a computing entity.

### DETAILED DESCRIPTION OF SOME EXAMPLE EMBODIMENTS

Embodiments disclosed herein generally relate to quantum annealing. More particularly, at least some embodiments relate to systems, hardware, software, computer-readable media, and methods for determining annealing schedules for problems based on subproblem similarities.

Embodiments of the invention are discussed in the context of problems expressed in quadratic unconstrained binary optimization (QUBO) form. Embodiments of the invention are not limited to this representation and may be implemented in the context of other forms, such as the Ising model.

Embodiments of the invention are further discussed in the context of quantum annealer. A quantum annealer may be real (i.e., a physical device that leverages quantum phenomena to perform optimization) and use qubits. A quantum annealer may also be simulated or emulated in classical hardware (e.g., processors, memory).

An annealing schedule, for quantum annealers, may describe a transition from an initial state to a final state. The annealing schedule may control how a problem's Hamiltonian is handled by the quantum annealer. In an annealing schedule, the quantum annealer is typically prepared to an initial state such as:

$${H}_{0} = - {\sum }_{i} {σ}_{i}^{x} .$$

This initial state is an example of a Hamiltonian that may be easy to create in a quantum annealer.

A problem Hamiltonian (Hₚ) encodes the problem being optimized and the ground state of Hₚ represents an optimal solution. The time-dependent Hamiltonian

$$H ( t ) = A ( t ) {H}_{0} + B ( t ) {H}_{P}$$

evolves according to the annealing schedule. Generally, A(t) starts at 1 and decreases to 0 while B(t) starts at 0 and increases to 1. At the end of the annealing schedule, the quantum annealer settles into a ground state of Hₚ, which represents an optimal solution to the problem.

Forward annealing (FA) in quantum annealers refers to a standard model where the optimization starts from a superposition of all states to find a final state (i.e., the final solution for the optimization problem). Reverse annealing (RA) is an annealing model that is useful to refine solutions by starting with a final state (i.e., a solution). RA then applies quantum fluctuations before returning to a new final state that could be better than the initial state. RA aids the annealing system in exploring the solution search space induced by the states of the initial solution, which allows better solutions to be found.

In both FA and RA models, a key parameter is the annealing scheduling. The annealing schedule stands for a pair of an annealing fraction and a duration in which the system will be maintained in its corresponding annealing fraction. In one example, the annealing fraction reflects the level of quantum fluctuations normalized between 0 and 1, where 0 stands for the superposition of all states and 1 stands for the final state.

For instance, FA starts the annealing scheduling evolution from 0 to 1, while RA starts with 1, reduces it to values above 0 and returns to 1. In both instances, a finite number of annealing steps are explicitly provided by the application user or automatically determined by the annealing system.

Defining an efficient annealing schedule is challenging, and may be as difficult as solving the original problem. Defining an efficient annealing schedule is even more complex when the problem is decomposed into smaller problems or subproblems. For example, a problem may be so large that the only way to fit the problem into a quantum annealer is to decompose the problem into smaller problems. Quantum annealers are limited by their number of qubits and this limitation directly impacts the size of the problem that can be solved by the hardware.

In the context of QUBOs, decomposing procedures are often referred to as cutting algorithms. In one example, the subproblems or subQUBOs may contain patterns or similarities because they are derived from the same problem definition of a root QUBO.

Generally, the dependency of quantum annealers on the annealing schedule cannot be overcome. Thus, the annealing schedule often impacts the final solution quality of a problem and the time to solution. Further, finding an optimal or even a sub-optimal annealing schedule may be, of itself, a hard optimization problem.

Embodiments of the invention relate to determining an annealing schedule for solving a QUBO more effectively compared to solving the QUBO using less well-informed annealing schedules that may be based on, for example, default parameters of a quantum annealer. Embodiments of the invention collect historical data, which may be related to executions in quantum annealers, to train a machine learning model such that efficient annealing schedules may be inferred.

Embodiments of the invention further employ decomposition (e.g., cutting) mechanisms and operations to handle large-size problems. In some examples, a similarity criterion may be used over the subproblems to accelerate and improve annealing schedule inferences. Byway of example, decomposition methods may be configured to subdivide a QUBO into subQUBOS and also compose the solutions of the subQUBOs into a solution that is equivalent to a solution of the original QUBO. Ising models can also be solved by a polynomial transformation in the variables to a QUBO.

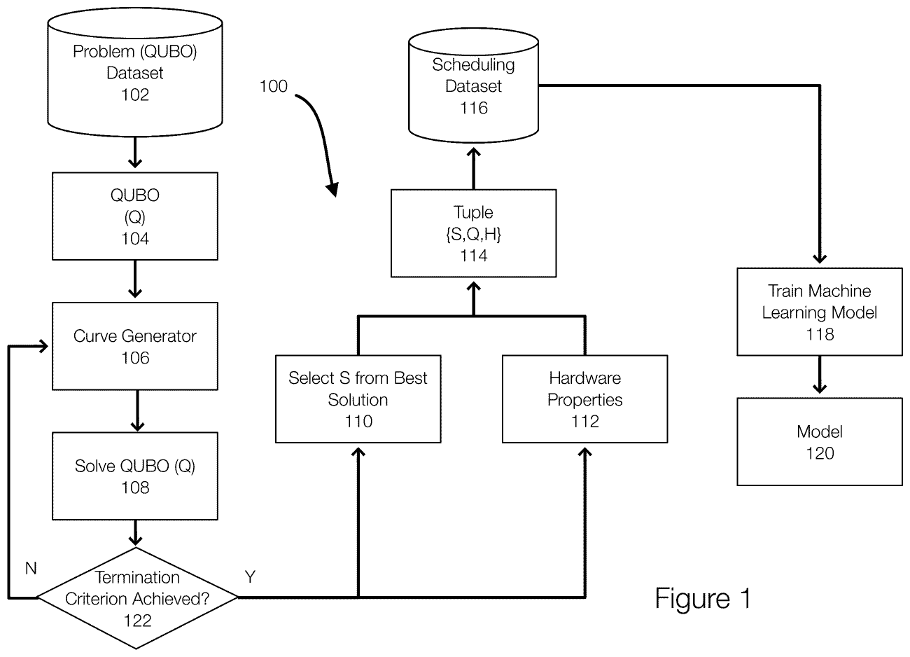

FIG. 1 discloses aspects of a training phase for training a machine learning model to infer an annealing schedule for a QUBO (or problem). FIG. 1 illustrates a training method 100 that begins with a QUBO dataset 102 (DQ). The dataset 102 includes QUBO problems and each QUBO problem is labeled with a type. Example labels include portfolio optimization problem, traveling salesperson problem, and random QUBO problem. Further, the dataset 102 is large and diverse at least from the perspective that, for each problem type, different QUBOs are present.

In one example, the method 100 may be performed for all QUBOs in the dataset 102. In the method 100, a QUBO (Q) 104 is selected from the dataset 102. Generally, the selected QUBO 104 is solved using different annealing schedules multiple times until a termination criterion is satisfied (e.g., a maximum number of repetitions or a period of time).

More specifically, the QUBO is solved multiple times. These solving iterations are performed as long as the termination criterion is not satisfied (N at 122). In each iteration, a curve generator 106 is used to generate or select a curve (e.g., an annealing schedule) and the QUBO is solved 108. More specifically, the method 100 may sample an annealing schedule from or using a curve generator 106. In one example, the curve generator 106 may contain a set of predefined curves. The set of curves may include curves from problems with similar settings as the QUBO 104.

Alternatively, the curve generator 106 may generate curves or annealing schedules randomly. A random generative process may determine a type of the curve and a set of unique parameters for the curve. In one example, each generated curve may be a monotonic increasing function (e.g., exponential or polynomial function) with a domain starting as (x=0, y=0) and ending at (x=1, y=1). Sampling the annealing schedule includes returning a list of points that are subject to the selected function. Thus, a sequence of x's may be randomly defined and the corresponding y's may be determined considering the curve. Once the annealing schedule is obtained from the curve, the QUBO 104 is solved 108. This allows, in one example, the annealing schedule to be represented as a series of data.

Thus, the process of selecting a curve or an annealing schedule and solving the QUBO 104 according is performed multiple times until the termination criterion is achieved. The termination criterion may be a set number of repetitions or performing repetitions for a predetermined amount of time. In one example, the termination criterion may be automatically determined (and may vary) and correspond to a point where a quality of the solutions to the QUBO 104 does not vary significantly considering a number of solutions using a quality threshold.

Once the termination criterion is met (Y at 122), this process of obtaining an annealing schedule and solving the QUBO is terminated. The best annealing schedule (S) 110 associated with the best solution found for the QUBO 104 (Q) is selected and hardware properties (H) 112 of the quantum annealer (e.g., number of qubits, connectivity graph, error rates, default parameters, coherence times) are collected to generate a tuple 114 (S, Q, H). The tuple 114 is stored in the scheduling dataset 116.

In one example, a pool of quantum annealers may be available for the method 100. Thus, the hardware properties 112 may vary in the tuples stored in the scheduling dataset 116.

Once the scheduling dataset 116 has been created, a machine learning model 120 is trained 118 using the scheduling dataset 116. Each tuple is used to train the model in one example. In the tuples, Q and H are considered as an input feature vectors while S represents sequential data that is, in the training phase, used to calculate a loss function. In an inference phase, the model 120 will predict or infer an annealing schedule S. In one example, the model 120 is a recurrent neural network (RNN), which may be trained to perform inferences of sequential data.

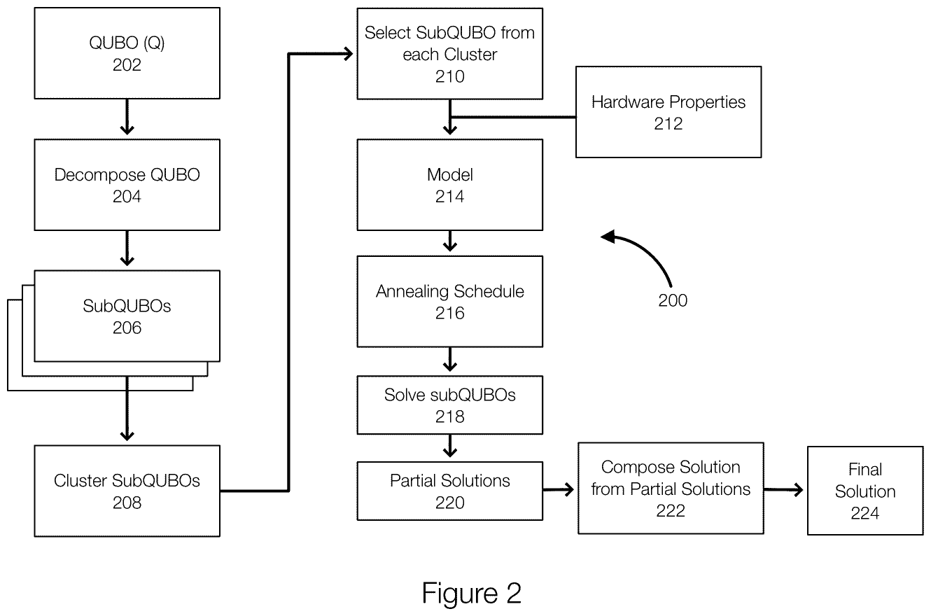

FIG. 2 discloses aspects of an inference phase for selecting an annealing schedule for a quantum annealer. The method 200 may begin when a QUBO 202 is received at, by way of example, an orchestration system, which may be implemented in classical computing hardware. The QUBO 202 is decomposed 204 into subQUBOs 206. Thus a QUBO Q 202 is decomposed into k subQUBOs 206.

The subQUBOs 206 are then clustered 208. In one example, the subQUBOs 206 are clustered into C disjoint clusters such that similar subQUBOs belong to the same cluster.

In one example, subQUBOs are clustered by their features (e.g., density, coefficient variability, qubit connectivity, etc.). A multidimensional vector can be derived from these features (i.e., a feature vector) from which a distance measure (e.g., Euclidean distance) can be employed to relate vectors in the same n-dimensional space, where n is the number of features. In one example, similar subQUBOs in terms of their features will be closer to each other (i.e., low distance). As the features being extracted are richer and diverse, the clustering results are expected to be more accurate. Clustering algorithms such as K-means and DBSCAN may be employed to perform this process in two distinct embodiments.

In another example, a graph-based approach can be performed by deriving a graph utilizing the multidimensional feature vectors cited earlier. In this example, each of the feature vectors is represented as a node in a graph. Next, an edge (i.e., a connection between two nodes) is added by considering a minimum threshold for its pair of nodes. As an example, an edge will exist if and only if the distance between its pair of nodes is below a minimum distance threshold. Determining this threshold may require an understanding of the cutting algorithm and this threshold may impact the graph's sparsity proportionally. Once the graph is completed, a community detection algorithm may be employed to find groups (i.e., clusters or communities) of similar subQUBOs. This approach may be more flexible in terms of preprocessing the multidimensional feature vectors (and removing unwanted connections) before grouping or clustering the subQUBOs.

In another example, an embedding for each subQUBO is obtained and a clustering algorithm is used to determine the clusters. Because a subQUBO is a matrix of coefficients, an embedding for a subQUBO can be obtained by using (or training) an image embedder. Each matrix coefficient from a subQUBO is associated to two variables (i.e., a pair of qubits), relating to a single-channel (e.g., gray-scale) pixel associated to (x, y) coordinate. These embeddings are data vectors which can be used as input to clustering algorithms, such as K-means and DBSCAN. Each of the clusters thus contains subQUBOs that have similarity.

Once the clusters are determined, a representative subQUBO from each cluster is selected 210. The representative subQUBOs may be selected from the clusters at random, using the most centralized subQUBO in each cluster based on a distance criterion or a clustering inner distance (e.g., medoid, or the highest betweenness), or based on another criterion.

The selected representative subQUBOs from the clusters are input (one at a time or using multiple instances of the model) to a model 214 (e.g., the model 120) along with hardware properties 212. Thus model 214 then infers, for each of the subQUBOs, an annealing schedule 216. A different annealing schedule may be inferred for each of the representative subQUBOs. The annealing schedules identified for the representative subQUBOs are then assigned to all subQUBOs in the corresponding clusters.

For example, a first annealing schedule predicted or inferred fora first representative subQUBO from a first cluster is then assigned to all subQUBOs that are in first cluster. A second annealing schedule predicted or inferred for a second representative subQUBO from a second cluster is assigned to all subQUBOs in the second cluster.

Next, all of the subQUBOS 206 are solved 218 using the assigned annealing schedules on the quantum annealer H (associated with hardware properties 212) in one example. The partial solutions 220 determined from solving the subQUBOs 206 are then composed 222 to generate a final solution 224 to the QUBO 202.

Embodiments of the invention thus determine an efficient annealing schedule by sequential data predicted from a model using hardware properties and subQUBO features as input. For a large QUBO, the large QUBO is decomposed and a similarity criterion is used to group the subQUBOS into clusters and representative subQUBOS from the clusters are used during the inference phase to identify an annealing schedule. In one example, the quality of the annealing schedules can be refined by considering a quality gap of subQUBOs solved on classical solvers and in quantum annealers.

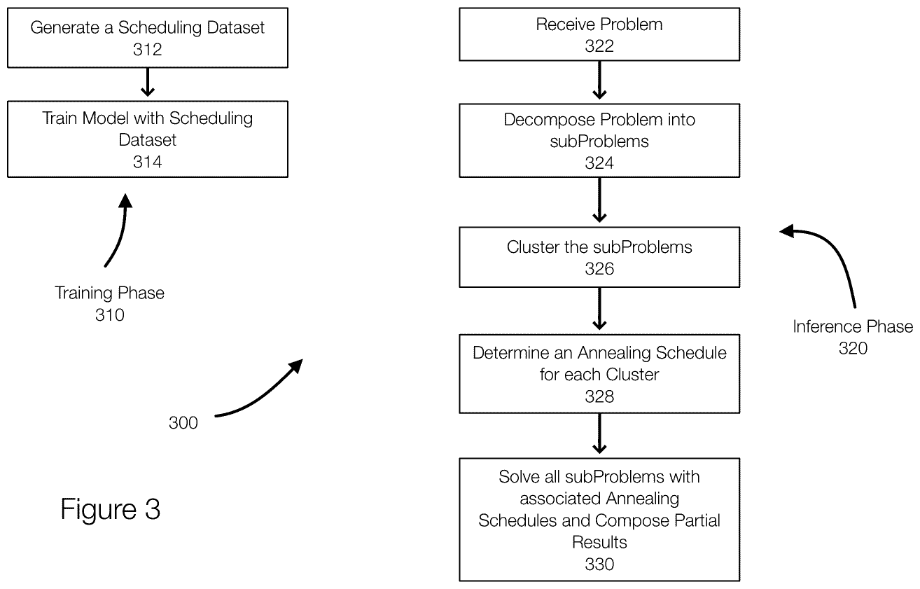

FIG. 3 discloses aspects of a method for solving a problem on a quantum annealer. The method 300 includes a training phase 310 and an inference phase 320, which are related but may be performed separately. The training phase 310 of the method 300 includes generating 312 a scheduling dataset. This is achieved by repeatedly solving problems from a problem dataset (e.g., a QUBO dataset) based on various annealing schedules (e.g., sampled or obtained from a curve generator) in order to generate a tuple (S,Q,H) that include a best annealing schedule (out of solving iterations performed) (S), the problem (Q), and hardware properties (H). Once the scheduling dataset is generated 312, a model is trained 314 using the scheduling dataset.

After the training phase 310 generates a trained model, an inference phase 320 may be performed. The inference phase 320 is generally configured to predict or infer an annealing schedule for a problem or for subproblems of the problem. The inference phase 320 may leverage similarities of the subproblems.

More specifically, a problem to be solved is received 322, for example at an orchestration system. The problem is decomposed 324 (cut) into subproblems. The subproblems are clustered 326 such that similar clusters can be grouped into clusters that contain similar subproblems.

Once the clusters are determined, an annealing schedule is determined 328 for each cluster. More specifically, a representative subproblem is selected from each of the clusters. The trained model is used to determine or infer an annealing schedule for each of the selected subproblems. Next, all of the subproblems are assigned the annealing schedule of the associated representative subproblem. Thus, each of the subproblems in each of the clusters is assigned with a particular annealing schedule determined by a model from a representative subproblem.

Next, using the assigned annealing schedules, all subproblems are solved and the partial solutions are composed together to generate a solution to the original problem.

Embodiments of the invention advantageously ensure that annealing schedules are selected to effectively solve a problem using historical data and a trained model. Further, annealing schedules can be selected for groups of subproblems based on their similarity. This advantageously allows annealing schedules to be selected for all subproblems.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, QUBO related operations, QUBO decomposition operations, subQUBO clustering operations, annealing schedule generation operations, machine learning training/inference operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide functionality for one or more clients. Another example of a cloud computing environment is one in which processing, quantum circuit execution, data protection, and other, services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a problem at an orchestration system configured to orchestrate execution of the problem in a quantum annealer, decomposing the problem into subproblems, clustering the subproblems into clusters of subproblems, determining an annealing schedule for a representative subproblem from each of the clusters with a model and assigning the annealing schedule assigned to the representative subproblems to the subproblems in the associated clusters, executing the subproblems in each of the clusters based on the assigned annealing schedules in a quantum annealer, and composing partial solutions generated for the subproblems into a solution to the problem.

Embodiment 2. The method of embodiment 1, wherein the problem is a quadratic unconstrained binary optimization (QUBO) problem and the subproblems are subQUBOs.

Embodiment 3. The method of embodiment 1 and/or 2, wherein the model is trained to infer the annealing schedules using a scheduling dataset of tuples, wherein each tuple includes an annealing schedule, a problem, and hardware properties.

Embodiment 4. The method of embodiment 1, 2, and/or 3, further comprising generating the scheduling dataset by repeatedly solving each problem in a problem dataset, wherein each iteration for each of the problems uses an annealing curve generated by a curve generator, wherein the annealing schedule in each tuple is the best annealing schedule identified from the iterations.

Embodiment 5. The method of embodiment 1, 2, 3, and/or 4, wherein the annealing schedule in the tuple represents sequential data that is used to calculate a loss function in the training phase.

Embodiment 6. The method of embodiment 1, 2, 3, 4, and/or 5, wherein the subproblems are clustered using K-means clustering, BDSCAN clustering, a graph-based method that uses feature vectors, and/or embeddings of the subproblems.

Embodiment 7. The method of embodiment 1, 2, 3, 4, 5, and/or 6, further comprising selecting the representative subproblems from each of the clusters, wherein the annealing schedule for each of the representative problems is determined by inputting the representative subproblems into the model.

Embodiment 8. The method of embodiment 1, 2, 3, 4, 5, 6, and/or 7, wherein the representative subproblem of each cluster is selected at random, using a distance criterion, or a highest betweenness.

Embodiment 9. The method of embodiment 1, 2, 3, 4, 5, 6, 7, and/or 8, wherein the quantum annealer is a real quantum annealer or an emulated quantum annealer in classical computing hardware.

Embodiment 10. The method of embodiment 1, 2, 3, 4, 5, 6, 7, 8, and/or 9, further comprising refining the annealing schedules by considering a quality gap of subproblems solved when the quantum annealer is a classical annealer and when the quantum annealer is a real quantum annealer.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

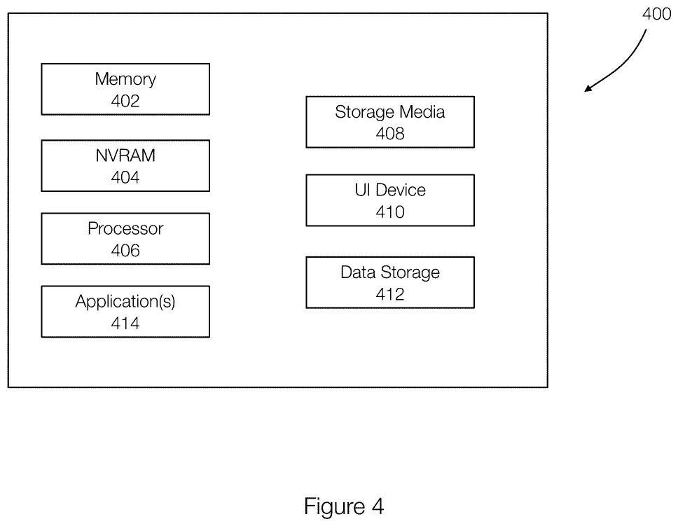

With reference briefly now to FIG. 4, any one or more of the entities disclosed, or implied, by the Figures, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 400 may be configured to perform quantum operations as a simulated or emulated quantum processing unit or quantum annealer. The device 400 may also be used in aspects of orchestrating the execution of a problem in a quantum annealer, which may include determining annealing schedules for subproblems of a problem.

The described embodiments are to be considered in all respects only as illustrative and not restrictive. All changes which come within the meaning and range of equivalency of the claims are to be embraced within their scope.

What is claimed is:

1. A method comprising:
receiving a problem at an orchestration system configured to orchestrate execution of the problem in a quantum annealer;
decomposing the problem into subproblems;
clustering the subproblems into clusters of subproblems;
determining an annealing schedule for a representative subproblem from each of the clusters with a model and assigning the annealing schedule assigned to the representative subproblems to the subproblems in the associated clusters;
executing the subproblems in each of the clusters based on the assigned annealing schedules in a quantum annealer; and
composing partial solutions generated for the subproblems into a solution to the problem.

2. The method of claim 1, wherein the problem is a quadratic unconstrained binary optimization problem (QUBO) and the subproblems are subQUBOs.

3. The method of claim 1, wherein the model is trained to infer the annealing schedules using a scheduling dataset of tuples, wherein each tuple includes an annealing schedule, a problem, and hardware properties.

4. The method of claim 3, further comprising generating the scheduling dataset by repeatedly solving each problem in a problem dataset, wherein each iteration for each of the problems uses an annealing curve generated by a curve generator, wherein the annealing schedule in each tuple is a best annealing schedule identified from the iterations.

5. The method of claim 4, wherein the annealing schedule in the tuple represents sequential data that is used to calculate a loss function in a training phase.

6. The method of claim 1, wherein the subproblems are clustered using K-means clustering, BDSCAN clustering, a graph-based method that uses feature vectors, and/or embeddings of the subproblems.

7. The method of claim 1, further comprising selecting the representative subproblems from each of the clusters, wherein the annealing schedule for each of the representative problems is determined by inputting the representative subproblems into the model.

8. The method of claim 7, wherein the representative subproblem of each cluster is selected at random, using a distance criterion, or a highest betweenness.

9. The method of claim 1, wherein the quantum annealer is a real quantum annealer or an emulated quantum annealer in classical computing hardware.

10. The method of claim 1, further comprising refining the annealing schedules by considering a quality gap of subproblems solved when the quantum annealer is a classical annealer and when the quantum annealer is a real quantum annealer.

11. A non-transitory storage medium having stored therein instructions that are executable by one or more hardware processors to perform operations comprising:
receiving a problem at an orchestration system configured to orchestrate execution of the problem in a quantum annealer;
decomposing the problem into subproblems;
clustering the subproblems into clusters of subproblems;
determining an annealing schedule for a representative subproblem from each of the clusters with a model and assigning the annealing schedule assigned to the representative subproblems to the subproblems in the associated clusters;
executing the subproblems in each of the clusters based on the assigned annealing schedules in a quantum annealer; and
composing partial solutions generated for the subproblems into a solution to the problem.

12. The non-transitory storage medium of claim 11, wherein the problem is a quadratic unconstrained binary optimization problem (QUBO) and the subproblems are subQUBOs.

13. The non-transitory storage medium of claim 11, wherein the model is trained to infer the annealing schedules using a scheduling dataset of tuples, wherein each tuple includes an annealing schedule, a problem, and hardware properties.

14. The non-transitory storage medium of claim 13, further comprising generating the scheduling dataset by repeatedly solving each problem in a problem dataset, wherein each iteration for each of the problems uses an annealing curve generated by a curve generator, wherein the annealing schedule in each tuple is a best annealing schedule identified from the iterations.

15. The non-transitory storage medium of claim 14, wherein the annealing schedule in the tuple represents sequential data that is used to calculate a loss function in a training phase.

16. The non-transitory storage medium of claim 11, wherein the subproblems are clustered using K-means clustering, BDSCAN clustering, a graph-based method that uses feature vectors, and/or embeddings of the subproblems.

17. The non-transitory storage medium of claim 11, further comprising selecting the representative subproblems from each of the clusters, wherein the annealing schedule for each of the representative problems is determined by inputting the representative subproblems into the model.

18. The non-transitory storage medium of claim 17, wherein the representative subproblem of each cluster is selected at random, using a distance criterion, or a highest betweenness.

19. The non-transitory storage medium of claim 11, wherein the quantum annealer is a real quantum annealer or an emulated quantum annealer in classical computing hardware.

20. The non-transitory storage medium of claim 11, further comprising refining the annealing schedules by considering a quality gap of subproblems solved when the quantum annealer is a classical annealer and when the quantum annealer is a real quantum annealer.
